(19) United States
(12) Patent Application Publication
(10) Pub. No.: US 2026/0157525 A1
(43) Pub. Date: Jun. 11, 2026

(54) AIR SUPPORT SYSTEM

(71) Applicants: HYUNDAI MOTOR COMPANY, Seoul (KR); KIA CORPORATION, Seoul (KR); HYUNDAI TRANSYS INC., Seosan-si (KR)

(72) Inventors: Sang Uk Yu, Hwaseong-si (KR); Soo Hyun Moon, Hwaseong-si (KR); Seung Young Lee, Hwaseong-si (KR); Ji Hwan Kim, Hwaseong-si (KR); Ki Ryung Lee, Hwaseong-si (KR); Dong Hoon Keum, Hwaseong-si (KR); Tae Hoon Lee, Hwaseong-si (KR); So Young Yoo, Hwaseong-si (KR); Hong Noh Park, Hwaseong-si (KR); Seong Yun Yeo, Hwaseong-si (KR)

(73) Assignees: HYUNDAI MOTOR COMPANY, Seoul (KR); KIA CORPORATION, Seoul (KR); HYUNDAI TRANSYS INC., Seosan-si (KR)

(21) Appl. No.: 19/200,305

(22) Filed: May 6, 2025

(30) Foreign Application Priority Data
Dec. 11, 2024 (KR) 10-2024-0183809

(51) Int. Cl. A47C 7/46; A47C 7/14

(52) U.S. Cl. CPC A47C 7/467; A47C 7/142

(57) ABSTRACT

An air support system includes: an outer plate, an inner plate rotatably and hingedly coupled to the outer plate, and a bladder fixed to the inner plate and provided between the outer plate and the inner plate. The bladder includes: a main part positioned on an upper surface of the outer plate, and a sub-part positioned on a lower surface of the inner plate. The sub-part includes a catching portion, the catching portion is connected to the inner plate, and an intake space is formed in the main part as the inner plate rotates when the sub-part expands.

### CROSS-REFERENCE TO RELATED APPLICATION

This application claims priority to Korean Patent Application No. 10-2024-0183809, filed on Dec. 11, 2024, the entire contents of which are incorporated herein by reference.

### BACKGROUND

### Field

The present disclosure relates to an air support system configured to be applied to a seat.

### Description of the Related Art

Seats in vehicles, office chairs, medical chairs, and the like may implement various functions using pressure of a fluid such as air. For example, the functions include a function of adjusting a height of a seat, a function of adjusting a backrest angle, and a function of supporting the lumbar vertebrae. The seat for a vehicle is described more specifically. Segmented cushions may be provided in a seat back frame to implement the lumbar support function, and a fluid may be injected into the cushion, which constitutes a lumbar support, under the control of an occupant to appropriately support lumbar vertebrae.

In a system that supports or apply pressure to a user's body using fluid pressure, a period of time is required to draw in the fluid and establish an appropriate pressure level. However, as the amount of time required to sufficient pressure to support the user's body increases, the marketability of the system deteriorates.

The statements in this section merely provide background information related to the present disclosure and may not constitute prior art.

### SUMMARY

Technical problems to be solved by the present disclosure are not limited to the above-mentioned technical problems, and other technical problems, which are not mentioned above, may be clearly understood from the following descriptions by those having ordinary skill in the art to which the present disclosure pertains.

The present disclosure provides an air support system including: an outer plate; an inner plate rotatably and hingedly coupled to the outer plate; and a bladder fixed to the inner plate and disposed between the outer plate and the inner plate. and the bladder includes: a main part positioned on an upper surface of the outer plate, and a sub-part positioned on a lower surface of the inner plate. The sub-part includes a catching portion, the catching portion is connected to the inner plate, and an intake space is formed in the main part as the inner plate rotates in response to expansion of the sub-part.

According to the embodiment, the outer plate may be fixedly coupled to a seat frame that defines an external shape of a seat.

According to the embodiment, the outer plate may be provided on at least one of a seat back frame or a seat cushion frame.

According to the embodiment, the bladder may rotate the inner plate by drawing in or discharging fluid.

According to the embodiment, the air support system may include: a pneumatic part configured to supply a fluid into the bladder or discharge the fluid. In particular, the pneumatic part is connected to a main part and a sub-part of the bladder.

According to the embodiment, the pneumatic part may include: a pump configured to pressurize and deliver the fluid; and a tube configured to supply the pressurized fluid into the bladder or discharge the fluid accommodated in the bladder.

According to the embodiment, the pneumatic part may further include: a valve connected to the tube; and a valve controller configured to supply the fluid into the bladder or discharge the fluid accommodated in the bladder by adjusting an opening degree of the valve.

According to the embodiment, the sub-part may include a sub-cushion. The main part may include: a first main cushion provided on the upper surface of the outer plate; and a second main cushion coupled to an upper surface of the first main cushion. The pneumatic part may be connected to the sub-cushion and the first main cushion and supply the fluid to the sub-part or discharge the fluid accommodated in the sub-part.

According to the embodiment, the pneumatic part may include a tube connected to the bladder, and the tube may include a first segment connected to the sub-cushion, and a second segment connected to the first main cushion. The tube directed toward the sub-cushion may be shorter than the tube directed toward the first main cushion, such that the fluid is supplied preferentially to the sub-cushion.

According to the embodiment, the inner plate may be rotated by the fluid drawn into the sub-part, such that the intake spaces are formed in the first main cushion and the second main cushion, respectively.

According to the embodiment, the first main cushion and the second main cushion may communicate with each other, the sub-cushion and the second main cushion may communicate with each other, and the fluid supplied to the sub-cushion and the first main cushion may be supplied to the second main cushion.

According to the embodiment, the sub-part is thermally bonded to the main part, and the sub-part and the main part may communicate with each other through a thermally bonded portion.

According to the embodiment, the intake space may be formed in the main part as the thermally bonded portion is pulled when the inner plate is rotated by the expansion of the sub-part.

According to the embodiment, the sub-part may include a sub-cushion. The main part may include: a first main cushion provided on the upper surface of the outer plate; and a second main cushion coupled to an upper surface of the first main cushion. The pneumatic part may be connected to the sub-cushion and the first main cushion and supply the fluid to the sub-part and the first main cushion or discharge the fluid accommodated in the sub-part and the first main cushion.

According to the embodiment, the pneumatic part may include a tube connected to the bladder, and the tube may include a first tube and a second tube, and the first and second tubes branch off from a predetermined point of the tube and are connected to the sub-cushion and the first main cushion, respectively. A length of the first tube directed toward the sub-cushion may be equal to or shorter than a length of the second tube directed toward the first main cushion.

According to an embodiment, an air support system comprises: an outer plate; an inner plate hingedly coupled to the outer plate; and a bladder disposed between the outer plate and the inner plate. The bladder includes: a main part disposed on a surface of the outer plate, and a sub-part disposed on a surface of the inner plate and coupled to the inner plate. In particular, the sub-part of the bladder is configured to expand and rotate the inner plate by drawing in fluid. When the inner plate rotates in response to expansion of the sub-part, an intake space is formed in the main part.

According to the air support system of the present disclosure, when the rotation of the inner plate is initiated, the intake space is ensured in the main part of the bladder, such that the fluid may be quickly drawn into the main part, and the inner plate may be rotated, thereby implementing the quick responsiveness of the air support system.

The effects obtained by the present disclosure are not limited to the aforementioned effects, and other effects, which are not mentioned above, will be clearly understood by those having ordinary skill in the art from the following description.

### BRIEF DESCRIPTION OF THE DRAWINGS

FIG. 1 is an exploded view of an air support system according to an embodiment of the present disclosure.

FIG. 2 is a view illustrating the air support system according to the embodiment of the present disclosure.

FIG. 3 is a view illustrating a state in which a rotation of an inner plate is initiated by a fluid drawn in by a sub-part.

FIGS. 4 to 6 are views illustrating a state in which the inner plate is rotated by the fluid drawn in by a bladder, according to an embodiment of the present disclosure.

FIG. 7 is a view illustrating a configuration in which the sub-part and a main part of the bladder are coupled by thermal bonding, according to an embodiment of the present disclosure.

FIGS. 8 and 9 are views illustrating a state in which the bladder and a pneumatic part are connected by a tube, according to an embodiment of the present disclosure.

FIGS. 10 and 11 are views illustrating a state in which the inner plate is rotated by the fluid drawn in by the bladder, according to an embodiment of the present disclosure.

FIG. 12 is a view for explaining connection between the bladder and the pneumatic part of the air support system, according to an embodiment of the present disclosure.

The drawings described herein are for illustration purposes only and are not intended to limit the scope of the present disclosure in any way.

### DETAILED DESCRIPTION

In the description of the embodiments disclosed in the present disclosure, the specific descriptions of publicly known related technologies have been omitted when it is determined that the specific descriptions may obscure the subject matter of the embodiments disclosed in the present disclosure. In addition, it should be interpreted that the accompanying drawings are provided only to allow those having ordinary skill in the art to easily understand the embodiments disclosed in the present disclosure, and the technical spirit disclosed in the present disclosure is not limited by the accompanying drawings, and includes all alterations, equivalents, and alternatives that are included in the spirit and the technical scope of the present disclosure. The following disclosure is not intended to limit the present disclosure to the specific form or field described, and it is contemplated that various alternative aspects and modifications of the present disclosure are possible, whether expressly stated or implied in the present disclosure. Those having ordinary skill in the art, to which the present disclosure pertains, should recognize that the form and details of the present disclosure may be changed.

The present disclosure refers to certain aspects by reference. However, as should be understood by those having ordinary skill in the art, various aspects disclosed in the present disclosure may be modified or otherwise implemented in various other ways without departing from the spirit and scope of the present disclosure. Therefore, the following description should be considered exemplary and is intended to teach those having ordinary skill in the art how to make and use the various embodiments. It should be understood that the specific forms illustrated and described in the present disclosure are to be taken as representative embodiments. Equivalent elements, materials, processes, or steps may be substituted for those representatively exemplified and described in the present disclosure. As used in the present disclosure, expressions such as “including,” “comprising,” “incorporating,” “have,” “is,” and the like should be construed in a non-exclusive manner, i.e., to permit items, constituent elements, or elements not expressly described to be shown. In addition, references to the singular should be interpreted as including references to the plural.

Further, various embodiments disclosed in the present disclosure are to be taken in an exemplary and illustrative sense and should not be construed as limiting the scope of the present disclosure. All references to joining (e.g., attached, affixed, coupled, connected, and the like) are intended to assist in understanding the present disclosure only and are not intended to limit the position, orientation, or use of the components or the methods disclosed in the present disclosure. Therefore, when references to joining are present, these should be interpreted broadly. Furthermore, these references to joining do not assume that two or more elements are directly connected to each other. Additionally, all numerical terms, e.g., “first,” “second,” “third,” “primary,” “secondary,” “major,” or any other generic or numerical term, are to be taken as identifiers only, to assist in understanding the various components, forms, variations, or modifications of the present disclosure, and are not intended to imply any limitation to any component, form, variation, or modification, or any order or preference thereof. These expressions may be used to describe various constituent elements, but the constituent elements are not limited by the corresponding expressions. The corresponding expressions are used only to distinguish one constituent element from another constituent element.

In the present disclosure, each of phrases such as “A or B”, “at least one of A or B”, “A, B or C”, “at least one of A, B or C” and “at least one of A, B, or C, or a combination thereof” may include any one or all possible combinations of the items listed together in the corresponding one of the phrases.

The suffixes “module”, “unit”, “part”, and “portion” used to describe constituent elements in the following description are used together or interchangeably in order to facilitate the description, but the suffixes themselves do not have distinguishable meanings or functions.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

In addition, the term “control unit” or “unit” included in the names is merely a term widely used to name a control device (controller or control unit) for controlling a particular vehicle function but does not mean a generic function unit.

A controller may include a communication device configured to communicate with another control unit or a sensor to control a corresponding function, a memory configured to store system software, a logic instruction, and input/output information, and one or more processors configured to perform determination, computation, decision, or the like required to control the corresponding function.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

In any configuration among the configurations disclosed in the present disclosure, any number of components or various components may be included in the present disclosure. The components may include any combination of the features disclosed in the present disclosure and be arranged in any configuration among various configurations disclosed in the present disclosure. The concepts related to the use and operations of the components of the present disclosure, as well as the structure and arrangement of the components of the present disclosure, may be applied not only to particular embodiments discussed in the present disclosure but also to any number of embodiments in any combination. The embodiments including various features of various arrangements are described below with reference to the drawings.

Hereinafter, various embodiments disclosed in the present disclosure are be described in detail with reference to the accompanying drawings. The same or similar constituent elements are assigned with the same reference numerals regardless of reference numerals, and the repetitive description thereof has been omitted.

According to the present disclosure, an air support system may be applied to any location where a person may be seated. However, for convenience of description, a configuration is described in which the air support system is installed in a seat for a vehicle. In addition, air may be representatively used as a fluid to be supplied to a bladder. In addition, other gases such as nitrogen may be used. Nitrogen may be more stable than air and be kept at predetermined pressure, such that the expansion and contraction of the bladder may be stably controlled even under an environment in which a temperature varies significantly. In particular, nitrogen less causes an oxidation reaction and has high sealability, which may provide an effect of improving durability of the bladder.

Therefore, the fluid to be supplied to the bladder is not limited to air, and an alternative gas, such as nitrogen, may be used to improve operational stability of the system.

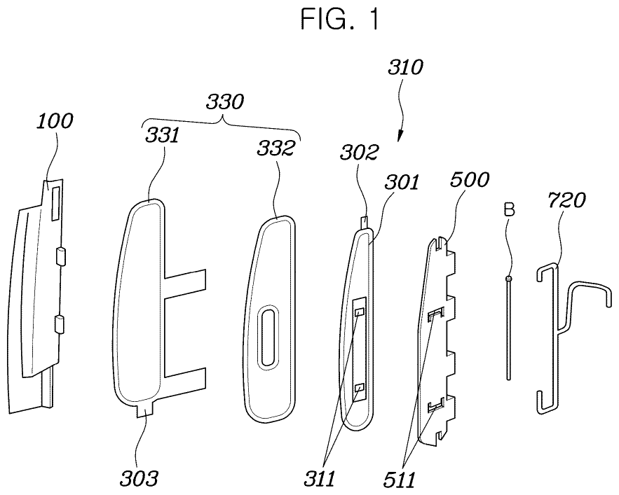

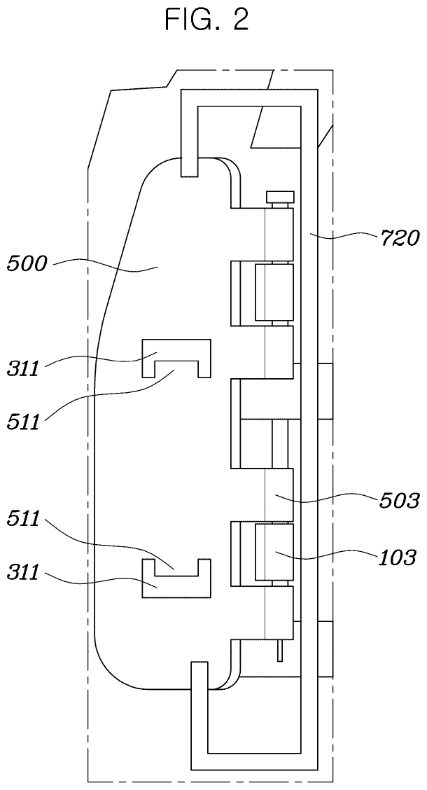

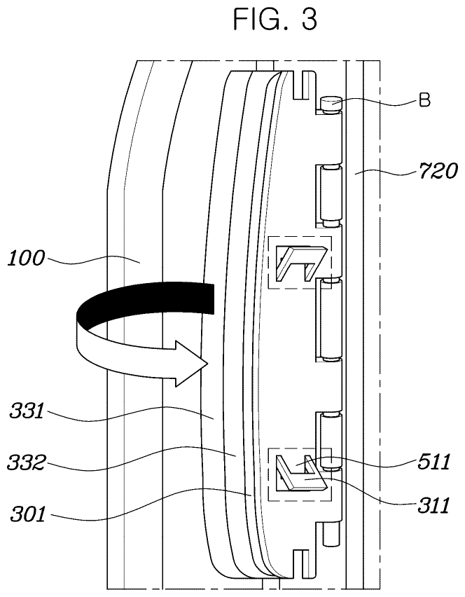

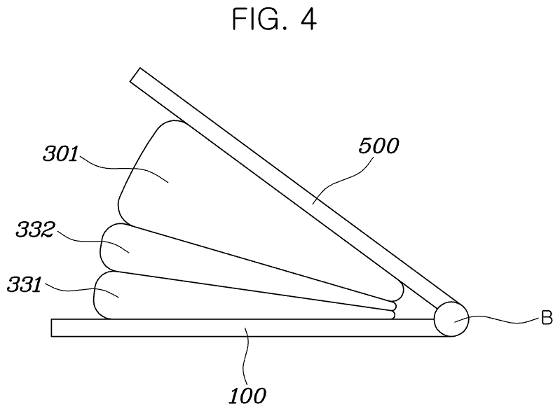

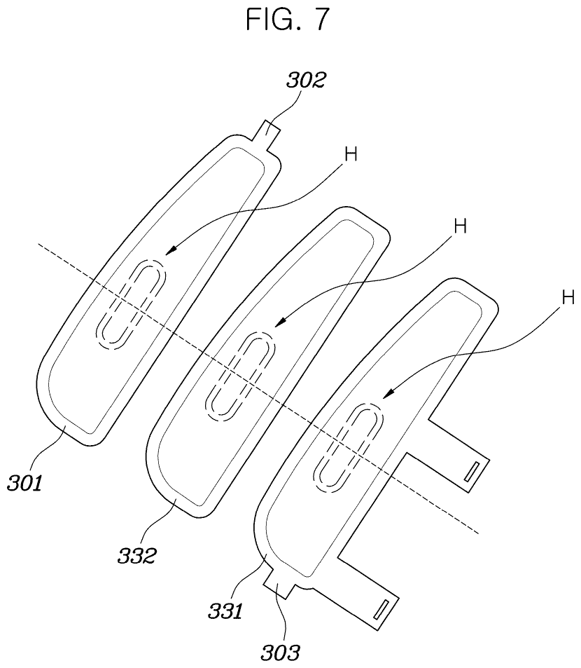

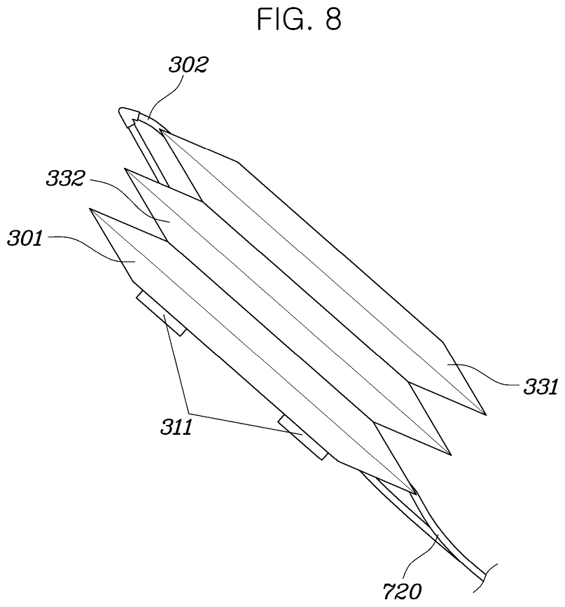

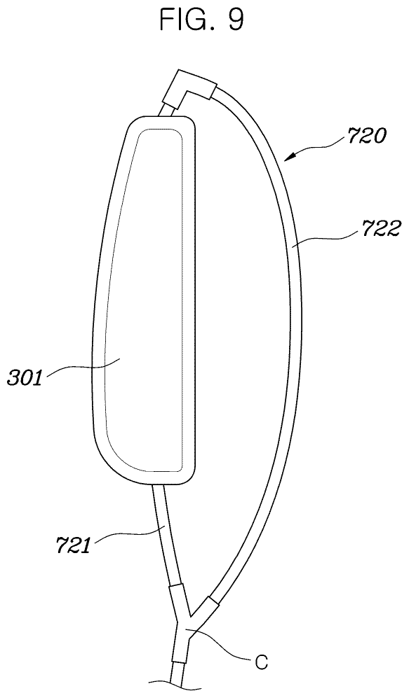

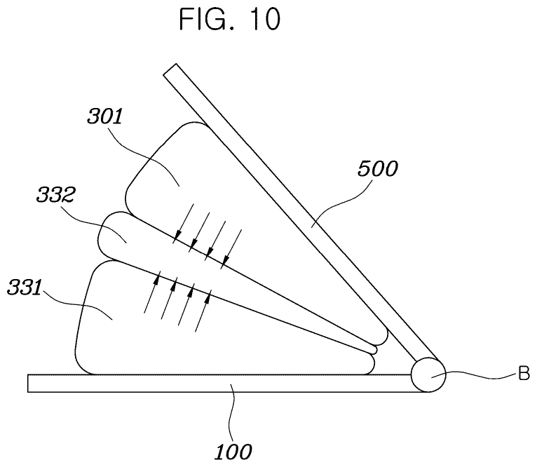

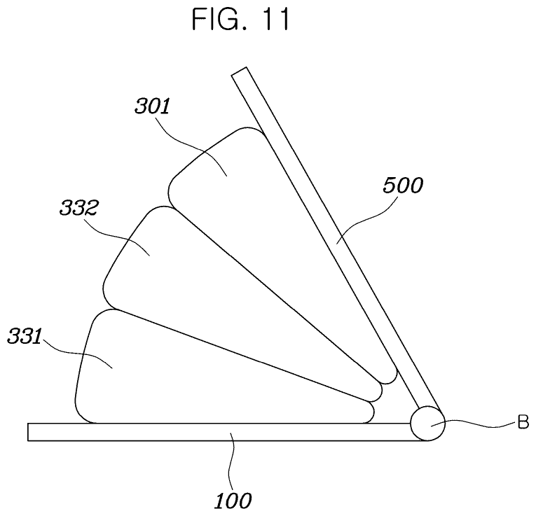

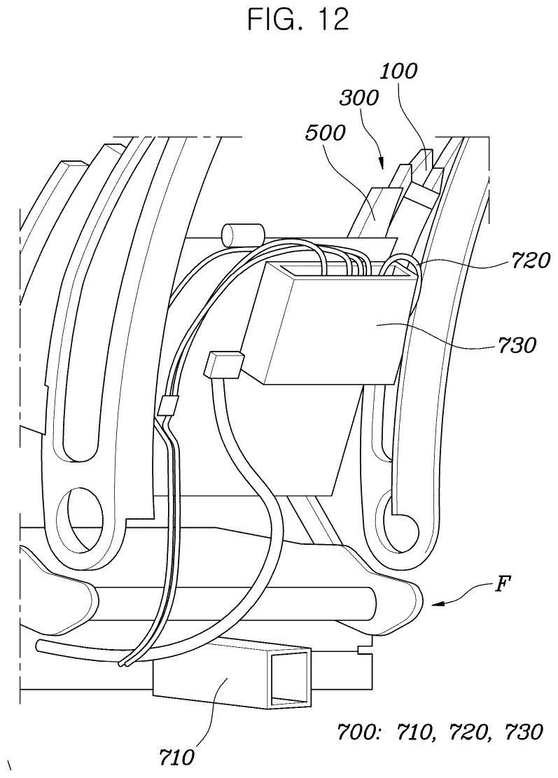

FIG. 1 is an exploded view of the air support system according to an embodiment of the present disclosure. FIG. 2 is a view illustrating the air support system according to the embodiment of the present disclosure. FIG. 3 is a view illustrating a state in which a rotation of an inner plate is initiated by a fluid drawn in by a sub-part. FIGS. 4 to 6 are views illustrating a state in which the inner plate is rotated by the fluid drawn in by a bladder. FIG. 7 is a view for explaining a configuration in which the sub-part and a main part of the bladder are coupled by thermal bonding. FIGS. 8 and 9 are views illustrating a state in which the bladder and a pneumatic part are connected by a tube. FIGS. 10 and 11 are views illustrating a state in which the inner plate is rotated by the fluid drawn in by the bladder. FIG. 12 is a view for explaining connection between the bladder and the pneumatic part of the air support system.

According to an embodiment, referring to FIGS. 1 and 12, an outer plate 100 constitutes an external structure of the air support system. The outer plate 100 may support the air support system including a bladder 300 and an inner plate 500. The outer plate 100 may include a hinge structure configured to facilitate a rotation of the inner plate 500. The outer plate 100 may have a fastening structure so that the outer plate 100 may be attached to a vehicle seat frame F. Further, the outer plate 100 may be made of an alloy or a composite material that satisfies both lightweight properties and durability. For example, aluminum alloy or high-strength plastic may be used as a material of the outer plate 100.

Referring to FIGS. 1-3, the inner plate 500 is hingedly coupled to the outer plate 100 so that the inner plate 500 may rotate about the outer plate 100. The inner plate 500 may be hingedly coupled to the outer plate 100 by a bolt B. A second fastening portion 503 of the inner plate 500 is disposed to overlap a first fastening portion 103 of the outer plate 100, which is fixedly attached to the vehicle seat frame F. The bolt B is inserted through and fastens both the first fastening portion 103 and the second fastening portion 503, such that the inner plate 500 may rotate about the outer plate 100. Further, hook portions 511 are formed at predetermined points on the inner plate 500, such that a sub-part 310 of the bladder 300 is connected to the hook portions 511 of the inner plate 500.

Meanwhile, the bladder 300 is positioned between the outer plate 100 and the inner plate 500. The bladder 300 may expand to induce the rotation of the inner plate 500 and thus allow the inner plate 500 to support a part of the user's body, and the bladder 300 may provide a supporting force. The bladder 300 includes the sub-part 310 and a main part 330. The sub-part 310 and the main part 330 may be configured as separate components. In another embodiment, the sub-part 310 and the main part 330 may be integrated while maintaining separate internal spaces.

The main part 330 of the bladder 300 is positioned on an upper surface of the outer plate 100, and the sub-part 310 of the bladder 300 is positioned on a lower surface of the inner plate 500. Further, catching portions 311 are formed on the sub-part 310, and the catching portions 311 are connected to the hook portions 511 of the inner plate 500. When the sub-part expands, the sub-part raises the inner plate 500 hingedly coupled to the outer plate 100, and the inner plate 500 begins to rotate. At the same time, the inner plate 500 may ensure an intake space in the sub-part 310 by means of the hook portions 511.

In a state in which the bladder 300 discharges the fluid, the inner plate 500 is positioned above the main part 330, and resistance elements against the drawn-in fluid are present in the main part 330 because of a load of the inner plate 500. In other words, the resistance in the main part 330, caused by the load of the inner plate 500, impedes fluid intake. However, when the inner plate 500 is rotated by the initial expansion of the sub-part 310, the resistance caused by the inner plate—previously acting as the resistance element against the drawn-in fluid-is reduced, such that an intake space may be formed in the main part 330. According to the embodiment, the hook portions 511 of the inner plate 500 may be provided as a pair of hook portions 511, and the catching portions 311 of the sub-part 310 may be provided as a pair of catching portions 311 corresponding to the hook portions 511. In other words, the hook portions 511 of the inner plate 500 may be provided as a pair, and the catching portions 311 of the sub-part 310 may be provided as a corresponding pair to engage with the hook portions 511.

As described above, as the sub-part 310 rotates the inner plate 500, the inner plate 500 simultaneously ensures the intake space in the sub-part 310 and removes the resistance present above the main part 330, thereby allowing the main part 330 to more smoothly draw in the fluid. The intake space, which is ensured as described above, enables the main part 330 to quickly and uniformly expand, thereby improving the responsiveness of the air support system.

According to the embodiment, the outer plate 100 may be fixedly coupled to the seat frame F that defines an external shape of the vehicle seat. The seat frame F may include any one of or both a seat back frame and a seat cushion frame. The outer plate 100 may be provided on any one of or both the seat back frame and the seat cushion frame.

In other words, in case that the air support system including the outer plate 100 is provided on the seat back frame, the inner plate 500 may be positioned at a backrest upper end portion and serve as a shoulder bolster that supports two opposite sides of the user's shoulder when the bladder 300 expands. This may enhance traveling stability by supporting the user's upper body, ensuring that the user's upper body remains securely in contact with the seat during rapid cornering or swaying of the vehicle body.

When the air support system, including the outer plate 100, is provided on the seat cushion frame, the air support system may function as a side bolster that supports user's buttocks and both sides of the user's waist. Even when the vehicle body tilts leftward and rightward or undergoes rapid rotation, this structure helps maintain the user's body in secure contact with the seat. This structure also provides a resistive force against a sway of the vehicle by increasing a close-contact force between the seat and the user's body. Therefore, it is possible to further improve the user's comfort and safety while the vehicle travels.

As described above, the air support system including the outer plate 100 is a structure that may serve as various bolsters in accordance with particular frame positions of the seat and provide a customized supporting force and stability that suit the user's body type and the traveling situation.

According to the embodiment, the bladder 300 may be structured to rotate the inner plate 500 by drawing in or discharging fluid. When the internal pressure is increased by the drawn-in fluid as the bladder 300 expands, the internal pressure pushes the inner plate 500 and initiates a rotational motion. In this case, because an expansion degree and an expansion speed of the bladder 300 may be adjusted in accordance with the amount of drawn-in fluid, a rotation angle may be finely adjusted to meet the user's needs.

Conversely, when the bladder 300 contracts due to fluid discharge, the internal pressure decreases, allowing the inner plate 500 to return to its an original position or stop rotating. This process may be automatically adjusted to change a posture required by the user or ensure stability, thereby contributing to providing the immediate supporting force and stability even while the vehicle travels.

Therefore, the bladder 300 controls the rotation of the inner plate 500 by means of the processes of drawing in and discharging the fluid. Therefore, the air support system acts as a main operational principle to provide a customized supporting force to the user.

In another embodiment, a pneumatic part 700 is provided inside the bladder 300 and configured to supply or discharge the fluid. With reference to FIG. 12, the pneumatic part 700 may be connected to the sub-part 310 of the bladder 300 and supply the fluid preferentially to the sub-part 310 or discharge the fluid accommodated in the sub-part 310.

The pneumatic part 700 may induce an initial rotation of the inner plate 500 by quickly controlling the expansion and contraction of the sub-part 310. In case that the fluid is supplied preferentially to the sub-part 310, the sub-part 310 may rapidly expand even with a relatively small amount of fluid, and the sub-part 310 may initiate the rotation while pushing the inner plate 500. Thereafter, when the fluid is supplied to the main part 330, the entire bladder 300 expands and provides a stable supporting force.

When the fluid accommodated in the sub-part 310 is discharged through the pneumatic part 700, the sub-part 310 may quickly contract to stop the rotation of the inner plate 500 or induce the inner plate 500 to return to its original position. Therefore, the bladder 300 may optimize the stability by quickly responding to a request to change and support the user's posture.

In an embodiment, the pneumatic part 700 may include a pump 710 configured to pressurize and transmit the fluid, and a tube 720 configured to supply the pressurized fluid to the inside of the bladder 300 or discharge the fluid accommodated in the bladder 300.

The pump 710 may pressurize the fluid to a desired pressure and supply the fluid to the bladder 300. The pump 710 may quickly induce the expansion of the bladder 300 by pressurizing the fluid, thereby adjusting the fluid pressure in accordance with the user's need. Therefore, the bladder 300 may expand and contract at an appropriate rate, thereby adjusting the responsiveness of the air support system.

The tube 720 functions as a passageway that supplies the fluid, which is pressurized by the pump 710, to the inside of the bladder 300 or discharges the fluid, which is accommodated in the bladder 300, to the outside. The tube 720 is designed to partition routes, through which the fluid is transmitted to the sub-part 310 and the main part 330 of the bladder 300, in order to accurately supply the fluid to a necessary portion or discharge the fluid. In particular, the fluid may be supplied or discharged preferentially to or from the sub-part 310, such that the inner plate 500 may be quickly rotated.

According to an embodiment, the pneumatic part 700 may further include a valve connected to the tube 720, and a valve controller 730 configured to control air supply to the inside of the bladder 300 or discharge of the fluid accommodated in the bladder 300 by adjusting an opening degree of the valve.

The valve is connected to the tube 720 of the pneumatic part 700 and serves as an entrance or exit that transmits the fluid to the bladder 300 or discharges the fluid. In other words, because the pump 710 functions to pressurize the fluid to necessary pressure and supply the fluid to the bladder 300, the pump 710 is connected to the valve, and a flow of the fluid is controlled by the valve before the fluid is supplied to the bladder 300 through the tube 720. When the pump 710 operates, the pressurized fluid moves toward the valve, and the valve opens or closes a movement route for the fluid, such that the flow of the fluid toward the bladder 300 is controlled. When the valve is closed, the fluid in the pump 710 is not transmitted to the bladder 300. When the valve is opened, the fluid pressurized by the pump 710 may be supplied to the bladder 300.

The valve is designed to adjust a change in pressure in the bladder 300. When the fluid is drawn in, the valve is opened so that the fluid is smoothly supplied to the bladder 300. When the bladder 300 has fully drawn in the fluid, the valve is closed. When the bladder 300 discharges the fluid, the valve is opened so that the fluid is effectively discharged.

The valve controller 730 refers to a device configured to adjust the opening degree of the valve. The valve controller 730 serves to supply the fluid with an accurate amount at an accurate rate to the inside of the bladder 300 or discharge the fluid accommodated in the bladder 300, thereby controlling the expansion and contraction of the bladder 300. The valve controller 730 may operate in conjunction with a control system in the vehicle and adjust the pressure in the bladder 300 depending on the traveling situation of the vehicle, thereby changing a degree to which the inner plate 500 supports the user.

According to an embodiment of the present disclosure, the sub-part 310 may include a sub-cushion 301, and the main part 330 may include a first main cushion 331 provided on an upper surface of the outer plate, and a second main cushion 332 coupled to an upper surface of the first main cushion 331. The pneumatic part 700 may be connected to the sub-cushion 301 and the first main cushion 331 and supply the fluid preferentially to the sub-part 310 or discharge the fluid accommodated in the sub-part 310.

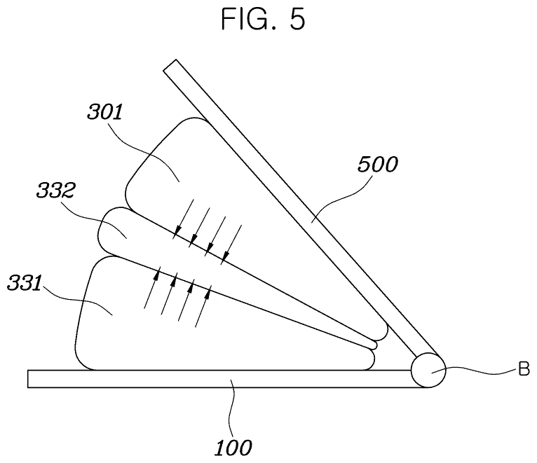

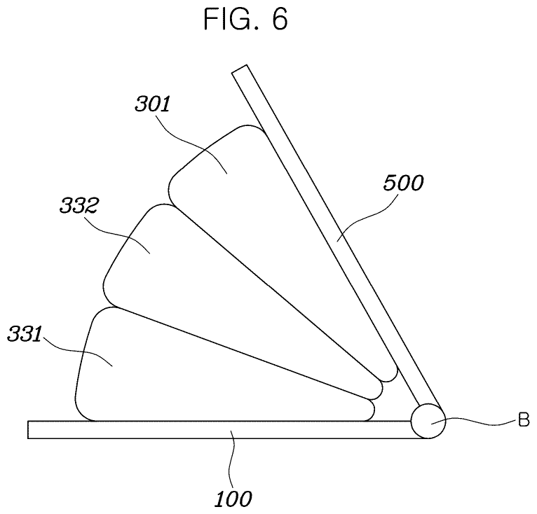

More specifically, the bladder 300 may include three cushions capable of drawing in or discharging the fluid. The sub-cushion 301 is a cushion to which the fluid is supplied first. The sub-cushion 301 is connected to the hook portion 511 of the inner plate 500 and rotates the inner plate 500 while simultaneously expanding. Therefore, as illustrated in FIG. 4, the intake spaces may be ensured in the first main cushion 331 and the second main cushion 332. In particular, the first main cushion 331 is a cushion into which the fluid is drawn in subsequently to the sub-cushion. The first main cushion 331 begins to expand after the sub-cushion 301 expands. Further, with reference to FIGS. 5 and 6, the fluid introduced into the first main cushion 331 and the sub-cushion 301 is supplied into the second main cushion 332 and initiates the expansion of the second main cushion 332. The above-mentioned sequential expansion mechanism may uniformly distribute the pneumatic pressure to the entire system. The sequential expansion mechanism may quickly expand the sub-cushion 301 first and then expand the first main cushion 331, such that the inner plate 500 may be quickly rotated, thereby enhancing the responsiveness of the air support system. Thereafter, the second main cushion 332 may receive the fluid from the first main cushion 331 and the sub-cushion 301 and uniformly distribute the pneumatic pressure.

According to an embodiment, the pneumatic part includes the tube 720 connected to the bladder 300. With reference to FIGS. 8 and 9, the tube 720 may be connected to the sub-cushion 301 and the first main cushion 331. In an embodiment, the tube 720 may include: a first segment 721 connected to the sub-cushion 301, and a second segment 722 connected to the first main cushion 331. The two segments (i.e., the first segment 721 and the second segment 722) extend in different directions from a predetermined branch point C of the tube 720, leading to separate fluid pathways. A length of the first segment 721 directed toward the sub-cushion 301 is designed to be shorter than a length of the second segment 722 directed toward the first main cushion 331, such that the fluid may be supplied preferentially to the sub-cushion 301. The difference in length and the design may control the flow of the fluid so that the sub-cushion 301 is filled with the fluid first, such that the initial rotation of the inner plate 500 may be quickly induced, thereby improving the responsiveness of the air support system and ensuring the intake spaces in the first main cushion 331 and the second main cushion 332.

In addition, the tube 720 is connected to a first connection portion 302 of the sub-cushion 301 and a second connection portion 303 of the first main cushion 331. The first connection portion 302 and the second connection portion 303 are disposed at positions opposite to each other, such that the fluid introduced into the sub-cushion 301 and the first main cushion 331 may be uniformly distributed and transmitted to the second main cushion 332. The design of the first and second connection portions provided at the opposite positions assists in allowing the fluid to uniformly diffuse to the second main cushion 332 and optimizes the distribution of the pressure in the entire air support system.

Therefore, the sub-cushion 301 is filled with the fluid, and the inner plate 500 is rotated, such that the intake spaces may be gradually ensured in the first main cushion 331 and the second main cushion 332. As the spaces are sequentially ensured, the cushions expand in a stepwise manner. In particular, after the sub-cushion 301 begins to expand, the first main cushion 331 receives the fluid and enters a next expansion step. Subsequently, the second main cushion 332 expands and provides a final supporting force for the entire system.

With reference to FIGS. 7-8, the bladder 300 may be formed as the sub-part 310 is thermally bonded to the main part 330, and the sub-part 310 and the main part 330 may communicate with each other through a thermally bonded portion H. The thermally bonded portion H is structured to connect the two parts 310 and 330 so that the fluid may flow in the two parts 310 and 330 while sealability is maintained. The thermally bonded portion H assists the fluid in smoothly flowing in the bladder 300.

Because the sub-part 310 and the main part 330 are coupled by thermal bonding, the durability and stability of the bladder 300 may be reinforced, and the stable structure may be maintained even though the expansion and contraction are repeated while the vehicle travels. In addition, the communication structure through the thermally bonded portion H may allow the fluid to freely move between the sub-part 310 and the main part 330 and more effectively distribute the supporting force in accordance with the change in the user's body or the traveling situation.

With the thermal bonding and communication structure, the bladder 300 may provide a more consistent supporting force and contribute to improving the performance of the air support system.

In addition, when the inner plate 500 is rotated by the expansion of the sub-part 310, the thermally bonded portion H may be pulled, and the intake space may be ensured in the main part 330. This configuration may be implemented by the thermal bonding connection structure between the sub-part 310 and the main part, and the expansion of the sub-part 310 more effectively defines the intake space in the main part 330 while inducing the rotation of the inner plate 500.

According to still another embodiment of the present disclosure, the air support system may include a structure in which the fluid is almost simultaneously supplied to the sub-cushion 301 and the first main cushion 331. In still another embodiment, the sub-part 310 includes the sub-cushion 301, and the main part 330 includes the first main cushion 331 provided on the upper surface of the outer plate 100, and the second main cushion 332 coupled to the upper surface of the first main cushion 331. The pneumatic part 700 is designed to supply the fluid simultaneously to the sub-cushion 301 and the first main cushion 331 or discharge the fluid from the cushions.

Specifically, the pneumatic part 700 includes the tube 720 connected to the bladder 300, and the tube 720 branches off from a particular point (e.g., a predetermined point) and is connected to the sub-cushion 301 and the first main cushion 331. In this case, a length of the tube 720 directed toward the sub-cushion 301 is equal to or relatively shorter than a length of the tube 720 directed toward the first main cushion 331, such that the fluid may be supplied almost simultaneously to the two cushions.

Thereafter, the fluid introduced into the sub-cushion 301 and the first main cushion 331 uniformly moves to the second main cushion 332. This structure is designed to allow the fluid to be naturally introduced into the second main cushion 332 after the sub-cushion 301 and the first main cushion 331 expand to a predetermined level or higher.

While the specific embodiments of the present disclosure have been illustrated and described, it should be obvious to those having ordinary skill in the art that the present disclosure may be variously modified and changed without departing from the technical spirit of the present disclosure defined in the appended claims.

What is claimed is:

1. An air support system comprising:
an outer plate;
an inner plate rotatably coupled to the outer plate; and
a bladder fixed to the inner plate and disposed between the outer plate and the inner plate,
wherein the bladder includes:
a main part positioned on a surface of the outer plate, and
a sub-part positioned on a surface of the inner plate, and
wherein:
the sub-part includes a catching portion,
the catching portion is connected to the inner plate, and
an intake space is formed in the main part as the inner plate rotates in response to expansion of the sub-part.

2. The air support system of claim 1, wherein the inner plate includes a hook portion connected to the catching portion such that the bladder is fixed to the inner plate.

3. The air support system of claim 1, wherein the outer plate is fixedly coupled to a seat frame, the seat frame defining an external shape of a seat.

4. The air support system of claim 1, wherein the outer plate is disposed on at least one of a seat back frame or a seat cushion frame.

5. The air support system of claim 1, wherein the bladder rotates the inner plate by drawing in or discharging a fluid.

6. The air support system of claim 1, comprising:
a pneumatic part configured to supply a fluid into the bladder or discharge the fluid,
wherein the pneumatic part is connected to the main part and the sub-part of the bladder.

7. The air support system of claim 6, wherein the pneumatic part comprises:
a pump configured to pressurize and deliver the fluid; and
a tube configured to supply the pressurized fluid into the bladder or discharge the fluid accommodated in the bladder.

8. The air support system of claim 7, wherein the pneumatic part further comprises:
a valve connected to the tube; and
a valve controller configured to supply the fluid into the bladder or discharge the fluid accommodated in the bladder by adjusting an opening degree of the valve.

9. The air support system of claim 6, wherein the sub-part comprises a sub-cushion,
wherein the main part comprises:
a first main cushion provided on the surface of the outer plate; and
a second main cushion coupled to a surface of the first main cushion, and
wherein the pneumatic part is connected to the sub-cushion and the first main cushion and supplies the fluid preferentially to the sub-part or discharges the fluid accommodated in the sub-part.

10. The air support system of claim 9, wherein the pneumatic part comprises a tube connected to the bladder,
wherein the tube includes:
a first segment connected to the sub-cushion, and
a second segment connected to the first main cushion, and
wherein a length of the first segment is shorter than a length of the second segment such that the fluid is supplied preferentially to the sub-cushion.

11. The air support system of claim 9, wherein the inner plate is rotated by the fluid drawn into the sub-part, such that intake spaces are formed in the first main cushion and the second main cushion, respectively.

12. The air support system of claim 9, wherein the first main cushion and the second main cushion communicate with each other, the sub-cushion and the second main cushion communicate with each other, and the fluid supplied to the sub-cushion and the first main cushion is supplied to the second main cushion.

13. The air support system of claim 1, wherein the sub-part is thermally bonded to the main part, and the sub-part and the main part communicate with each other through a thermally bonded portion.

14. The air support system of claim 13, wherein the intake space is formed in the main part as the thermally bonded portion is pulled in response that the inner plate is rotated by the expansion of the sub-part.

15. The air support system of claim 6, wherein the sub-part comprises a sub-cushion,
wherein the main part comprises:
a first main cushion provided on the surface of the outer plate; and
a second main cushion coupled to a surface of the first main cushion and
wherein the pneumatic part is connected to the sub-cushion and the first main cushion and supplies the fluid to the sub-part and the first main cushion or discharges the fluid accommodated in the sub-part and the first main cushion.

16. The air support system of claim 15, wherein the pneumatic part comprises a tube connected to the bladder, and
wherein:
the tube includes a first tube and a second tube, and the first tube and the second tube branch off from a predetermined point of the tube and are connected to the sub-cushion and the first main cushion, respectively, and
a length of the first tube directed toward the sub-cushion is equal to or shorter than a length of the second tube directed toward the first main cushion.

17. An air support system comprising:
an outer plate;
an inner plate hingedly coupled to the outer plate; and
a bladder disposed between the outer plate and the inner plate,
wherein the bladder includes:
a main part disposed on a surface of the outer plate, and
a sub-part disposed on a surface of the inner plate and coupled to the inner plate,
wherein when the inner plate rotates in response to expansion of the sub-part, an intake space is formed in the main part, and
wherein the sub-part of the bladder is configured to expand and rotate the inner plate by drawing in fluid.

18. The air support system of claim 17, comprising:
a pneumatic part configured to supply the fluid into the bladder or discharge the fluid,
wherein the pneumatic part is connected to the main part and the sub-part of the bladder.

19. The air support system of claim 18, wherein the pneumatic part comprises:
a pump configured to pressurize and deliver the fluid; and
a tube configured to supply the pressurized fluid into the bladder or discharge the fluid accommodated in the bladder.

20. The air support system of claim 18, wherein the sub-part comprises a sub-cushion,
wherein the main part comprises:
a first main cushion provided on a surface of the outer plate; and
a second main cushion coupled to a surface of the first main cushion, and
wherein the pneumatic part is connected to the sub-cushion and the first main cushion and supplies the fluid preferentially to the sub-part or discharges the fluid accommodated in the sub-part.
